(19) United States
(12) Patent Application Publication
(10) Pub. No.: US 2024/0338599 A1
(43) Pub. Date: Oct. 10, 2024

(54) ADAPTING A LANGUAGE MODEL FOR MULTIMODAL MULTI-TASK LEARNING

(71) Applicant: SRI International, Menlo Park, CA (US)

(72) Inventors: Karan SIKKA, Robbinsville, NJ (US); Michael COGSWELL, Yardley, PA (US); Pritish SAHU, Piscataway, NJ (US); Meng YE, Pennington, NJ (US); Abrar RAHMAN, Brooklyn, NY (US); Rohit SRIDHAR, San Jose, CA (US); Ajay DIVAKARAN, Monmouth Junction, NJ (US)

(21) Appl. No.: 18/619,916

(22) Filed: Mar. 28, 2024

Related U.S. Application Data
(60) Provisional application No. 63/457,706, filed on Apr. 6, 2023.
(60) Provisional application No. 63/457,712, filed on Apr. 6, 2023.
(60) Provisional application No. 63/457,716, filed on Apr. 6, 2023.

(51) Int. Cl. G06N 20/00

(52) U.S. Cl. CPC G06N 20/00

(57) ABSTRACT

A method, apparatus and system for adapting a language model for understanding domain-specific multimodal content include acquiring domain-specific multimodal content for at least one content domain and applying question/answer pairs to the acquired, domain-specific multimodal content for the at least one content domain to train the language model to learn tasks associated with the domain-specific multimodal content for the at least one domain. As such, the trained language model can be implemented to answer questions directed to the domain-specific multimodal content for the at least one domain.

### CROSS-REFERENCE TO RELATED APPLICATIONS

This application claims benefit of and priority to U.S. Provisional Patent Application Ser. No. 63/457,706, filed Apr. 6, 2023, and U.S. Provisional Patent Application Ser. No. 63/457,712, filed Apr. 6, 2023, and U.S. Provisional Patent Application Ser. No. 63/457,716, filed Apr. 6, 2023 which are all herein incorporated by reference in their entireties.

### GOVERNMENT RIGHTS

This invention was made with U.S. Government support under Contract Number HR0011-22-9-0024 awarded by the Defense Advanced Research Projects Agency. The U.S. Government has certain rights in the invention.

### FIELD

Embodiments of the present principles generally relate to task learning using language models and, more particularly, to a method, apparatus and system for the adaptation of large language models for in-context learning in multimodal domains.

### BACKGROUND

Content understanding today consists of implementing language models to answer questions about/using the content. Recent large language models such as GPT-3 are able to generalize knowledge obtained from content to new tasks, however for narrow tasks, fail to truly understand the content. That is, for specific tasks, state of the art language models are functionally “stochastic parrots” or “smart/super parrots” that simply memorize without deeper comprehension. That is, current pre-trained language models have lots of knowledge, but a more limited ability to use that knowledge. In addition, language models are typically trained and respond to questions with reference to only text/word content and not multimodal content.

### SUMMARY

Embodiments of methods, apparatuses and systems for adapting a language model for understanding domain-specific multimodal content are disclosed herein.

In some embodiments, a method for adapting a language model for understanding domain-specific multimodal content includes acquiring domain-specific multimodal content for at least one content domain, and applying question/answer pairs to the acquired, domain-specific multimodal content for the at least one content domain to train the language model to learn tasks associated with the domain-specific multimodal content.

In some embodiments, the method further includes using the trained language model to answer questions directed to the domain-specific multimodal content for the at least one domain.

In some embodiments, a non-transitory machine-readable medium has stored thereon at least one program, the at least one program including instructions which, when executed by a processor, cause the processor to perform a method in a processor-based system for adapting a language model for understanding domain-specific multimodal content including acquiring domain-specific multimodal content for at least one content domain, and applying question/answer pairs to the acquired, domain-specific multimodal content for the at least one content domain to train the language model to learn tasks associated with the domain-specific multimodal content.

In some embodiments, the method of the non-transitory machine-readable medium further includes using the trained language model to answer questions directed to the domain-specific multimodal content for the at least one domain.

In some embodiments, an apparatus for adapting a language model for understanding domain-specific multimodal content includes a knowledge acquisition module, a task learning module, a processor, and a memory accessible to the processor, the memory having stored therein at least one of programs or instructions. In some embodiments, when the programs or instructions are executed by the processor, the apparatus is configured to acquire, using the knowledge acquisition module, domain-specific multimodal content for at least one content domain, and apply, using the task learning module, question/answer pairs to the acquired, domain-specific multimodal content for the at least one content domain to train the language model to learn tasks associated with the domain-specific multimodal content.

In some embodiments, the apparatus is further configured to use the trained language model to answer questions directed to the domain-specific multimodal content for the at least one domain.

In some embodiments, a computer-implemented method for training a language model for understanding domain-specific multimodal content includes acquiring a set of domain-specific multimodal content data for at least one content domain, using a machine learning model, creating a set of question/answer pairs to apply to the domain-specific multimodal content data, creating a training set comprising the acquired set of domain-specific multimodal content data and the created question/answer pairs, and training the language model using the training set by applying the question/answer pairs to the acquired, domain-specific multimodal content for the at least one content domain to train the language model to learn tasks associated with the domain-specific multimodal content.

In some embodiments, a method for implementing a trained language model to answer inquiries directed to domain-specific multimodal content for the at least one domain includes receiving an inquiry directed at the domain-specific multimodal content and providing a response to the inquiry using the trained language model. In some embodiments, the language model is trained by acquiring a set of domain-specific multimodal content data for at least one content domain, using a machine learning model, creating a set of question/answer pairs to apply to the domain-specific multimodal content data, creating a training set comprising the acquired set of domain-specific multimodal content data and the created question/answer pairs, and training the language model using the training set by applying the question/answer pairs to the acquired, domain-specific multimodal content for the at least one content domain to train the language model to learn tasks associated with the domain-specific multimodal content.

Other and further embodiments in accordance with the present principles are described below.

### BRIEF DESCRIPTION OF THE DRAWINGS

So that the manner in which the above recited features of the present principles can be understood in detail, a more particular description of the principles, briefly summarized above, may be had by reference to embodiments, some of which are illustrated in the appended drawings. It is to be noted, however, that the appended drawings illustrate only typical embodiments in accordance with the present principles and are therefore not to be considered limiting of its scope, for the principles may admit to other equally effective embodiments.

FIG. 1 depicts a high-level block diagram of a multi-modal language model adapter in accordance with an embodiment of the present principles.

FIG. 2 depicts a functional diagram of a multi-modal language model adapter in accordance with an embodiment of the present principles.

FIG. 3 depicts an illustrative example of a question/answering process (e.g., an autodidact process) for multimodal content for a specific domain in accordance with an embodiment of the present principles.

FIG. 4 depicts a functional diagram of an LLM having been adapted by a multi-modal language model adapter of the present principles to learn the task of making curry in accordance with an embodiment of the present principles.

FIG. 5 depicts a flow diagram of a method for adapting a language model for understanding domain-specific multimodal content in accordance with an embodiment of the present principles.

FIG. 6 depicts a high-level block diagram of a computing device suitable for use with embodiments of a comprehension-based question answering system in accordance with the present principles.

FIG. 7 depicts a high-level block diagram of a network in which embodiments of a comprehension-based question answering system in accordance with the present principles, can be applied.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present principles generally relate to methods, apparatuses and systems for adaptation of language models for in-context learning in multimodal domains. That is, embodiments of the present principles provide methods, apparatus and systems for adapting a language model for understanding domain-specific multimodal content by training a language model to learn tasks associated with domain-specific multimodal content. While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims. For example, although embodiments of the present principles will be described primarily with respect to implementing specific question/answer pairs associated with particular domain-specific multimodal content for the adaptation and training of language models, such teachings should not be considered limiting. Embodiments in accordance with the present principles can function with substantially any question/answer pairs associated with other domain-specific multimodal content for the adaptation and training of language models.

Throughout the teachings herein, the phrase “question/answer pair” is used to define a data pair that describes an inquiry regarding data and a solution to that inquiry. Such data pair can be used to train a model as described herein. Although embodiments of the present principles described herein implement the phrase “question/answer pair”, alternatively or in addition, in some embodiments, the phrase “prompt/response” can also be used in addition to and/or in place of the phrase “question/answer pair” to describe the data pair that describes the inquiry regarding data and the solution to that inquiry.

Embodiments of the present principles provide a method, apparatus and system for adapting language models, such as Large Language Models (LLMs), to understand and then answer questions for focused domains, which can be performed on-the-fly. In some embodiments, an LLM is adapted by only adapting a few parameters (which can be considered adapters). In some specific embodiments, a novel approach disentangles the adaptation of an LLM to a new domain into Knowledge Acquisition and Task Learning/training for efficient learning. Such an adaption of the present principles can be very useful for domains in which it is hard to get large amounts of data.

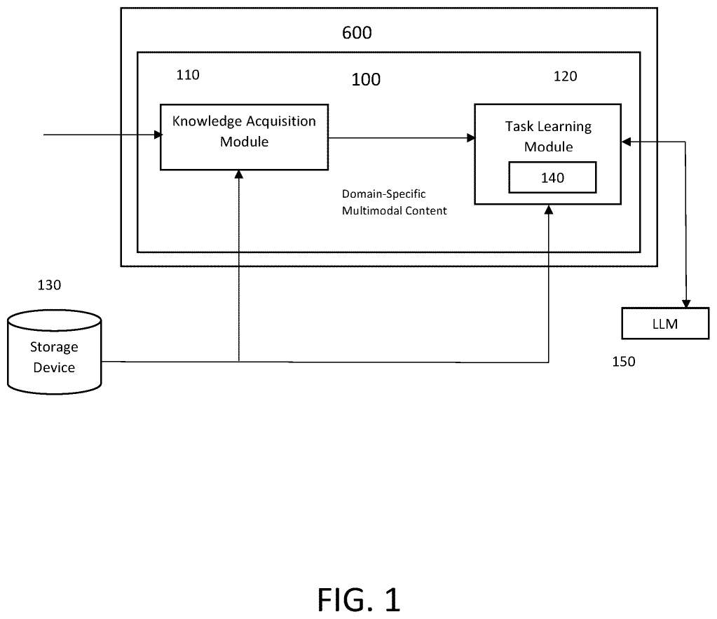

FIG. 1 depicts a high-level block diagram of a multi-modal language model adapter 100 in accordance with an embodiment of the present principles. The multi-modal language model adapter 100 of FIG. 1 illustratively comprises a knowledge acquisition module 110, a task learning module 120, and an optional storage device 130. In the embodiment of FIG. 1, the task learning module 120 of the multi-modal language model adapter 100 can include a machine learning system 140. In the embodiment of FIG. 1, the multi-modal language model adapter 100 is in communication with an LLM 150 for purposes of adapting/training the LLM 150 to perform specific tasks using domain-specific multimodal language. Although in the embodiment of the multi-modal language model adapter 100 of FIG. 1 the LLM 150 is depicted as a separate component from the multi-modal language model adapter 100, in some embodiments of the present principles, the LLM 150 can be included as a component of a multi-modal language model adapter of the present principles, such as the multi-modal language model adapter 100 of FIG. 1.

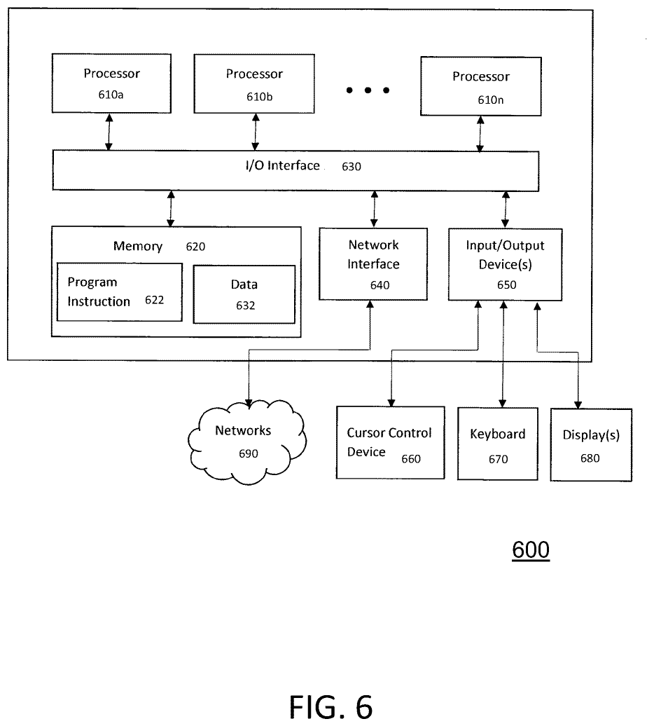

As further depicted in FIG. 1, embodiments of a multi-modal language model adapter of the present principles, such as the multi-modal language model adapter 100 of FIG. 1, can be implemented via a computing device 600 in accordance with the present principles (described in greater detail below with reference to FIG. 6).

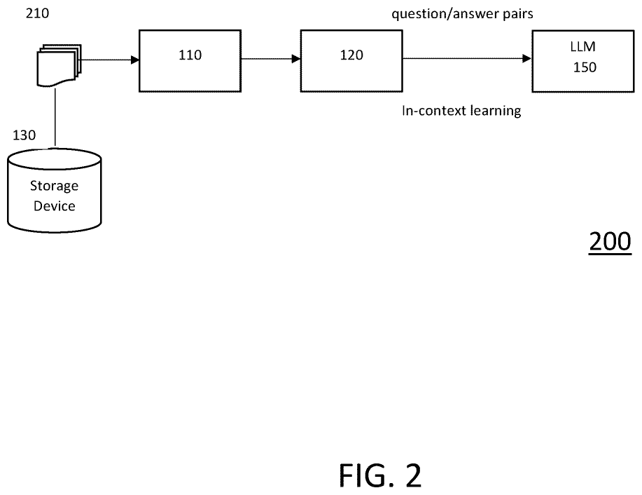

FIG. 2 depicts a functional diagram 200 of a multi-modal language model adapter 100 in accordance with an embodiment of the present principles. In the embodiment of FIG. 2, multimodal content/documents 210 (e.g., images, text, audio, videos, etc., and any combination thereof) can be acquired by a knowledge acquisition module of the present principles, such as the knowledge acquisition module 110 of the multi-modal language model adapter 100 of FIG. 1. In some embodiments, multimodal content 210 specific to at least one domain (in some embodiments two or three or more domains) can be received by the knowledge acquisition module 110, the domain-specific content intended to adapt an associated language model, such as a Large Language Model (LLM), to understand and/or answer questions for the focused domain(s) represented by the acquired multimodal content in accordance with the present principles.

In some embodiments and as depicted in FIG. 2, the multimodal content can be acquired by the knowledge acquisition module 110 from the optional storage device 130. That is, in some embodiments the optional storage device 130 can be configured to, upon prompting, communicate multimodal content of one or more specific content domains to the knowledge acquisition module 110 of the multi-modal language model adapter 100. For example, in some embodiments, a user can implement an input device of, for example, the computing device 600, to communicate with the optional storage device 130 to prompt the storage device to communicate multimodal content of one or more specific domains to the knowledge acquisition module 110 of the multimodal language model adapter 100 of FIG. 1. Embodiments of the present principles adapt a typically text-only language model, such as an LLM, into a multimodal language model using the acquired domain-specific, multimodal content in accordance with the present principles and as described in further detail below. Although the embodiment of FIG. 2 is described above as acquiring multimodal content from the optional storage device 130, in some embodiments of the present principles, domain-specific multimodal content can be acquired from other sources of multimodal content, such as from user input.

Alternatively or in addition, in some embodiments of the present principles, the knowledge acquisition module 110 of the multimodal language model adapter 100 of FIG. 1 can search the LLM 150 to acquire content (multimodal or otherwise) of a particular domain(s) to adapt the LLM 150 to understand and/or answer questions for the particular domain(s) represented by the acquired content in accordance with the present principles. Although typically LLMs only contain single mode (textual) content, in embodiments in which an LLM contains multimodal content, embodiments of the present principles can use multimodal content acquired from the LLM to adapt the LLM to understand and/or answer questions for the particular domain(s) represented by the acquired multimodal documents in accordance with the present principles (described in greater detail below).

In embodiments of the present principles, the domain-specific content acquired by a knowledge acquisition module of the present principles, such as the knowledge acquisition module 110 of the multimodal language model adapter 100 of FIG. 1, can be conditioned by, for example a knowledge acquisition module of the present principles, for enabling the application of question/answer pairs to the domain-specific content to train a language model, such as an LLM, to perform tasks directed to the domain-specific content. For example, in some embodiments domain-specific tools for extracting content can be implemented by a knowledge acquisition module of the present principles, such as the knowledge acquisition module 110 of the multimodal language model adapter 100 of FIG. 1. That is, in some embodiments to extract domain-specific relevant data (images, text, audio, video, and/or a combination thereof) from acquired pdf documents, a knowledge acquisition module of the present principles can implement a pypdf2 tool, which includes a free and open-source pure-python PDF library capable of splitting, merging, cropping, and transforming the pages of PDF files and can also add custom data, viewing options, and passwords to PDF files.

Once the relevant data is obtained, off-the-shelf cleaning tools, such as clean-text can be implemented by, for example a knowledge acquisition module of the present principles, to preprocess and clean the text. That is, clean text is human language rearranged into a format that machine models can understand and can be performed using a simple Python code that eliminates stopwords, removes unicode words, and simplifies complex words to their root form. In addition, in some embodiments, images and their corresponding text can also be associated using heuristics or tools such as unstructured.io for parsing the pdf document into relevant parts such as, image and associated captions, paragraph title etc. That is, unstructured.io provides libraries with open-source components for pre-processing text documents such as PDFs, HTML and Word Documents. The above described tools and applications represent only an example of tools that can be implemented in accordance with the present principles to condition acquired domain-specific content and should not be considered limiting.

Referring back to FIG. 1 and FIG. 2, in some embodiments of the present principles, the knowledge acquired by the knowledge acquisition module 110 of the multi-modal language model adapter 100 of FIG. 1 can be used by the task learning module 120 to train the LLM 150 to learn tasks. For example, in some embodiments, the task learning module 120 can apply a question/answering process (e.g., an autodidact process) to multimodal content acquired by the knowledge acquisition module 110 to train the LLM 150 to learn tasks associated with the acquired, domain-specific multimodal content.

For example, in some embodiments of the present principles, the task learning module 120 of the multi-modal language model adapter 100 of FIG. 1 can implement an in-context learning approach to adapt an LLM, such as the LLM 150 of FIG. 1, to few-shot learning of tasks associated with the acquired, task-specific multimodal content. That is, embodiments of the present principles expand the concepts of textual in-context learning to multimodal in-context learning of language models, such as the LLM 150 of FIG. 1. In some embodiments, at test time, a task learning module of the present principles, such as the task learning module 120 of the multi-modal language model adapter 100 of FIG. 1, can provide examples of multimodal task performances, which can include acquired task-specific multimodal content and associated labels, to train the LLM 150 using the example multimodal content (e.g., images) and, for example, question/answer pairs. In such embodiments, the LLM 150 learns the task at hand through the example multimodal content (e.g., text, images, audio, videos, etc., and any combination thereof) provided at test time (i.e., the LLM 150 adapts to the task at hand on the fly at test time by learning from the examples provided at test time). As such, embodiments of the present principles enable an LLM, such as the LLM 150 to adapt to any multimodal task as long as a few examples (i.e., question/answer pairs for domain-specific multimodal content) are provided at test time.

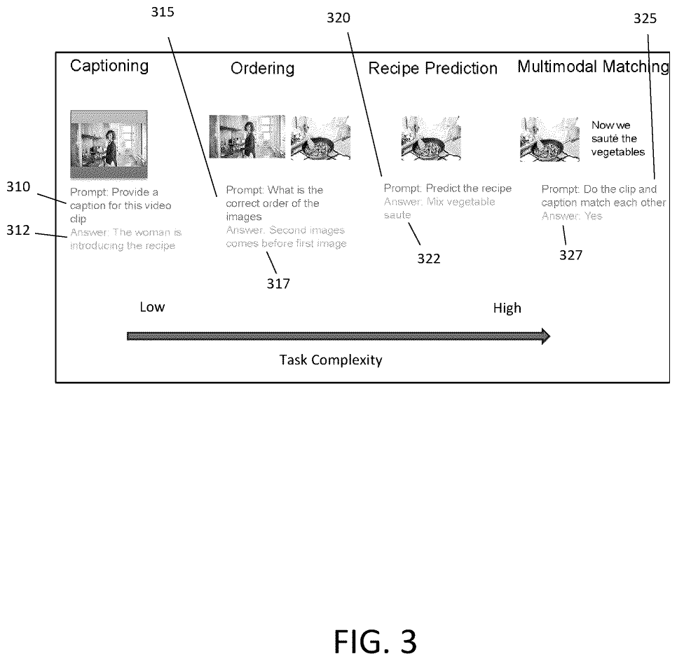

For example, FIG. 3 depicts an illustrative example of a multi-modal, in-context learning approach including a question/answering process 300 (e.g., an autodidact process) to be applied to domain-specific multimodal content acquired by a knowledge acquisition module of the present principles, and specifically associated with preparing a dish according to a recipe, to train a language model, such as the LLM 150, to learn tasks associated with the preparation of a recipe in accordance with an embodiment of the present principles. In the embodiment depicted in FIG. 3, the questions applied to the multimodal content comprise questions of increasing task complexity. That is, in some embodiments of the present principles, the questions of the question/answer pairs can comprise layers of at least one hierarchical taxonomy, which can include a Bloom's taxonomy.

Specifically, in the embodiment of FIG. 3, a first question 310 applied to an image of a video clip of a woman in a kitchen recites “Provide a caption for this video clip?”. The first question 310 can be classified as a captioning question. In accordance with the present principles, the answer “The woman is introducing the recipe” 312 is provided for the first question 310 for the image of a video clip of a woman in a kitchen to train the LLM 150 to learn the task. In the embodiment of FIG. 3, a second question 315 applied to the task specific multimodal content recites “What is the correct order of the images?”. The second question 315 is a little higher in task complexity and is classified as an ordering question. In accordance with the present principles, the answer “Second image comes before first image” 317 is provided for the second question 315.

In the embodiment of FIG. 3, a third question 320 applied to the task specific multimodal content recites “Predict the recipe”. The third question 320 is still a little higher in task complexity and is classified as a prediction question. In accordance with the present principles, the answer “Mix vegetable saute” 322 is provided for the third question 320. In the embodiment of FIG. 3, a fourth question 325 applied to the task specific multimodal content recites “Do the clip and caption match?”. The fourth question 325 is still a little higher in task complexity and is classified as multimodal matching question. Similar to the first 310, the second 315, and the third 320 questions, embodiments of the present principles provide an answer “Yes” 327 to the fourth 325 question to train an LLM, such as the LLM 150, to learn tasks to adapt the LLM 150 to understand and/or answer questions for the particular domain(s) represented by the multimodal content in accordance with the present principles.

In some embodiments, question/answer pairs of the present principles can be predetermined and stored in a memory accessible to at least the task learning module 120 to be available for application to acquired content for training an LLM as described above. Alternatively or in addition, in some embodiments, question/answer pairs to be applied to domain-specific multimodal content in accordance with the present principles can be received by a multi-modal language model adapter of the present principles, such as the multi-modal language model adapter 100 of FIG. 1, along with domain specific multimodal content to which the question/answer pairs are to be applied.

Referring back to the multi-modal language model adapter 100 of FIG. 1, in some embodiments, the task learning module 120 can include a machine learning system 140. The machine learning system 140 of the task learning module 120 can be trained to identify appropriate question/answer pairs to apply to multimodal content based on the multimodal content acquired by the knowledge acquisition module 110. That is, in some embodiments of the present principles, the machine learning system 140 of the task learning module 120 can include a multi-layer neural network comprising nodes that are trained to have specific weights and biases. In some embodiments, the machine learning system 140 can employ artificial intelligence techniques or machine learning techniques to analyze domain-specific multimodal content to identify appropriate question/answer pairs to apply to the content. In some embodiments in accordance with the present principles, suitable machine learning techniques can be applied to learn commonalities in sequential application programs and for determining from the machine learning techniques at what level sequential application programs can be canonicalized. In some embodiments, machine learning techniques that can be applied to learn commonalities in sequential application programs can include, but are not limited to, regression methods, ensemble methods, or neural networks and deep learning such as ‘Seq2Seq’ Recurrent Neural Network (RNNs)/Long Short-Term Memory (LSTM) networks, Convolution Neural Networks (CNNs), graph neural networks applied to the abstract syntax trees corresponding to the sequential program application, and the like. In some embodiments a supervised machine learning (ML) classifier/algorithm could be used such as, but not limited to, Multilayer Perceptron, Random Forest, Naive Bayes, Support Vector Machine, Logistic Regression and the like. In addition, in some embodiments, the ML classifier/algorithm of the present principles can implement at least one of a sliding window or sequence-based techniques to analyze data content.

In some embodiments, the machine learning system 140 of the task learning module 120 of FIG. 1 can be trained using a plurality (e.g., hundreds, thousands, millions, etc.) of instances of question/answer pairs and associated domain-specific multimodal content to which the question/answer pairs apply for training a model/algorithm of the present principles for automatically applying question/answer pairs to acquired domain-specific multimodal content to train an LLM to perform tasks related to the domain-specific multimodal content to adapt the LLM to understand and answer questions for focused domains. In such embodiments of the present principles, the model can be trained to associate question/answer pairs that best flush out the composition of the domain-specific multimodal content to be applied to the multimodal content during training of an LLM. That is, once a model is trained, the task learning module 120 can apply the model to automatically determine question/answer pairs to apply to the acquired domain-specific multimodal content based on the composition of the multimodal content.

Although in the embodiment of the multi-modal language model adapter 100 of FIG. 1, the task learning module 120 illustratively includes a machine learning system 140, which can be trained to identify appropriate question/answer pairs to apply to multimodal content, alternatively or in addition, in some embodiments a language model, such as the LLM 150 of FIG. 1, can be trained to identify appropriate question/answer pairs to apply to multimodal content in accordance with the present principles and as described above.

In some embodiments of the present principles, a conceptual consistency process can be used by a multi-modal language model adapter of the present principles, such as the multi-modal language model adapter 100 of FIG. 1, to improve knowledge acquisition. That is, in some embodiments, conceptual consistency is used to measure the LLM's 150 understanding of relevant concepts. A resultant metric measures how well a language model can be characterized by finding out how consistent the responses of the language model are to queries about conceptually relevant background knowledge. Using such information, a multi-modal language model adapter of the present principles, such as the multi-modal language model adapter 100 of FIG. 1, can determine if further training is needed to increase a consistency of responses of the language model to queries. In such embodiments, if further training is required, additional question/answer pairs can be implemented to train the language model. As such, embodiments of the present principles can further train a language model to learn to learn from a few examples what is the target task and how to carry it out (i.e., the atomic concept of the task). For example, if examples of sorting animals and buildings into separate categories are presented by a multi-modal language model adapter of the present principles, such as the multi-modal language model adapter 100 of FIG. 1, to an LLM at test time, the LLM can be trained to learn the underlying task of separating objects/groups into categories and can learn to separate images of, for example, birds and humans into different categories.

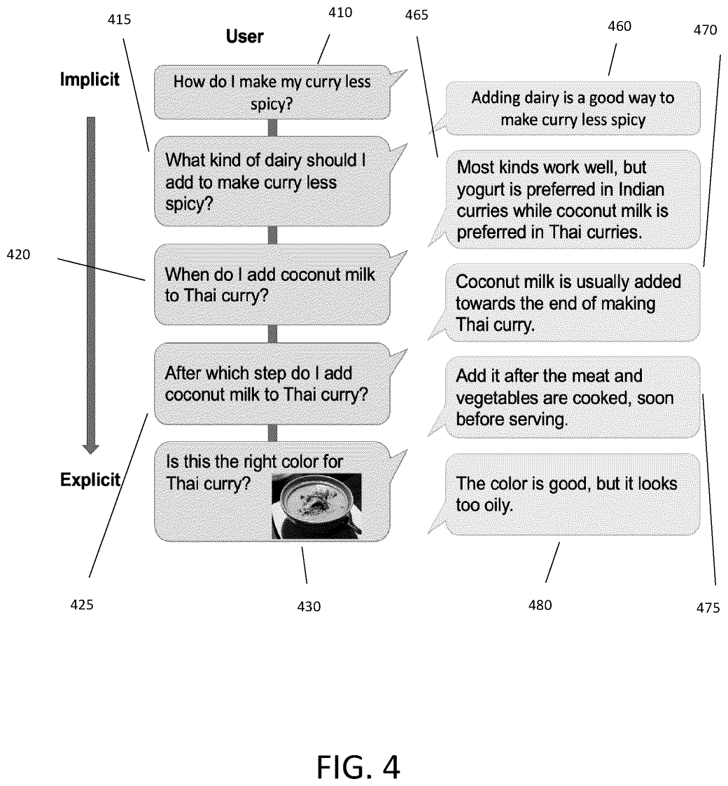

Once trained, a language model trained in accordance with the present principles can be implemented to understand and answer questions directed to the acquired, domain-specific multimodal content for at least one domain associated with the domain-specific multimodal content. For example, FIG. 4 depicts a functional diagram of an LLM, such as the LLM 150 of FIG. 1, having been trained and adapted by a multi-modal language model adapter of the present principles, such as the multi-modal language model adapter 100 of FIG. 1, to learn the task of making curry in accordance with an embodiment of the present principles. As depicted in FIG. 4, upon a user of the LLM 150 entering a first question 410 “How do I make my curry less spicy?”, the LLM 150, having been adapted by a multi-modal language model adapter of the present principles, such as the multi-modal language model adapter 100 of FIG. 1, to learn the task of making curry, responds with the phrase 460 “Adding dairy is a good way to make curry less spicy”. As depicted in FIG. 4, the first question 410 and response 460 are considered implicit. In the embodiment of FIG. 4, upon a user of the LLM 150 entering a second question 415 “What kind of dairy should I add to make curry less spicy?”, the LLM 150 adapted in accordance with the present principles responds with the phrase 465 “Most work well, but yogurt is preferred in Indian curries while coconut milk is preferred in Thai curries”. As depicted in FIG. 4, the second question 415 and response 465 are considered a little less implicit and more explicit.

In the embodiment of FIG. 4, upon a user of the LLM 150 entering a third question 420 “When do I add coconut milk to Thai curry?”, the adapted LLM 150 responds with the phrase 470 “Coconut milk is usually added during the end of making Thai curry”. As depicted in the embodiment of FIG. 4, the third question 420 and response 470 are considered even a little less implicit and more explicit. Furthermore, in the embodiment of FIG. 4, upon a user of the LLM 150 entering a fourth question 425 “After which step do I add coconut milk to Thai curry?”, the adapted LLM 150 responds with the phrase 475 “Add it after the meat and vegetables are cooked, soon before serving”. As depicted in the embodiment of FIG. 4, the fourth question 425 and response 475 are considered more explicit than implicit.

Finally, in in the embodiment of FIG. 4, upon a user of the LLM 150 entering a fifth question 430 “Is this the right color for Thai curry?” and including an image, the adapted LLM 150 responds with the phrase 480 “The color is good, but it looks too oily”. As depicted in the embodiment of FIG. 4, the fifth question 430 and response 480 are explicit. As depicted in the embodiment of FIG. 4, an LLM, adapted in accordance with the present principles, is able to understand and then answer questions for focused domains, having been adapted/trained using domain-specific multimodal content.

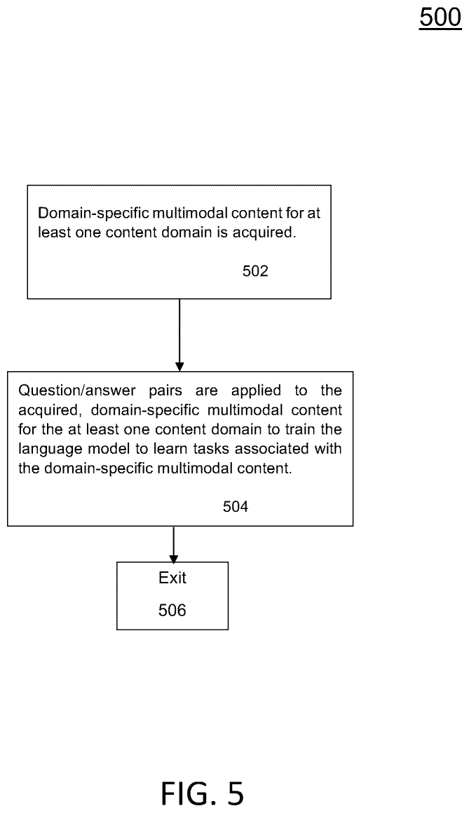

FIG. 5 depicts a flow diagram of a method 500 for adapting a language model for understanding domain-specific multimodal content in accordance with an embodiment of the present principles. The method 500 can begin at 502 during which domain-specific multimodal content is acquired for at least one content domain. For example and as described above, in some embodiments a knowledge acquisition module of the present principles, such as the knowledge acquisition module 110 of FIG. 1, can acquire domain-specific multimodal content from a storage device and/or from an associated language model. The method 500 can proceed to 504.

At 504, question/answer pairs are applied to the acquired, domain-specific multimodal content for the at least one content domain to train the language model to learn tasks associated with the domain-specific multimodal content. For example and as described above, in some embodiments a task learning module of the present principles, such as the learning module 120 of FIG. 1, applies question/answer pairs to the acquired, domain-specific multimodal content to adapt the associated language model to learn a task(s) associated with the acquired, domain-specific multimodal content, which enables the language model to understand and answer questions about the acquired, domain-specific multimodal content. That is, once the language model is adapted in accordance with the present principles, the language model is able to understand the domain-specific multimodal content and provide responses to prompts/tasks intended to be fulfilled using the content (and specifically the domain-specific multimodal content) accessible by the language model. The method 500 can then be exited at 506.

In some embodiments, the method 500 can further include using the trained language model to answer questions directed to the domain-specific multimodal content for the at least one domain.

In some embodiments, the method can further include using an in-context multimodal learning approach to train the language model to learn the tasks associated with the domain-specific multimodal content.

In some embodiments, in the method the domain-specific multimodal content is acquired from at least one of a storage device, a user input, or the language model.

In some embodiments, in the method the question/answer pairs are automatically selected and applied to the acquired, domain-specific multimodal content based on a composition of the acquired, domain-specific multimodal content.

In some embodiments, in the method, which question/answer pairs to apply to the acquired, domain-specific multimodal content are determined using a trained machine learning process.

In some embodiments, in the method the question/answer pairs applied to the acquired, domain-specific multimodal content comprise varying levels of complexity. In such embodiments, the question/answer pairs are applied to the acquired, domain-specific multimodal content as respective layers of at least one hierarchical taxonomy.

In some embodiments, a non-transitory machine-readable medium having stored thereon at least one program, the at least one program including instructions which, when executed by a processor, cause the processor to perform a method in a processor-based system for adapting a language model for understanding domain-specific multimodal content, including acquiring domain-specific multimodal content for at least one content domain, and applying question/answer pairs to the acquired, domain-specific multimodal content for the at least one content domain to train the language model to learn tasks associated with the domain-specific multimodal content.

In some embodiments, the method performed further includes using the trained language model to answer questions directed to the domain-specific multimodal content for the at least one domain.

In some embodiments, the method performed further includes using an in-context multimodal learning approach to train the language model to learn the tasks associated with the domain-specific multimodal content.

In some embodiments, in the method performed the domain-specific multimodal content is acquired from at least one of the non-transitory machine-readable medium, a user input, or the language model.

In some embodiments, in the method performed the question/answer pairs are automatically selected and applied to the acquired, domain-specific multimodal content based on a composition of the acquired, domain-specific multimodal content.

In some embodiments, in the method performed, which question/answer pairs to apply to the acquired, domain-specific multimodal content are determined using a trained machine learning process.

In some embodiments, in the method performed, the question/answer pairs applied to the acquired, domain-specific multimodal content comprise varying levels of complexity.

In some embodiments, in the method performed the question/answer pairs are applied to the acquired, domain-specific multimodal content as respective layers of at least one hierarchical taxonomy.

In some embodiments, an apparatus for adapting a language model for understanding domain-specific multimodal content includes a knowledge acquisition module, a task learning module, a processor, and a memory accessible to the processor, the memory having stored therein at least one of programs or instructions. In some embodiments, when the programs or instructions are executed by the processor, the apparatus is configured to acquire, using the knowledge acquisition module, domain-specific multimodal content for at least one content domain, and apply, using the task learning module, question/answer pairs to the acquired, domain-specific multimodal content for the at least one content domain to train the language model to learn tasks associated with the domain-specific multimodal content.

In some embodiments, the apparatus is further configured to use the trained language model to answer questions directed to the domain-specific multimodal content for the at least one domain.

In some embodiments, the apparatus is further configured to use an in-context multimodal learning approach to train the language model to learn the tasks associated with the domain-specific multimodal content.

In some embodiments, the domain-specific multimodal content is acquired from at least one of the non-transitory machine-readable medium, a user input, or the language model.

In some embodiments, the question/answer pairs are automatically selected and applied to the acquired, domain-specific multimodal content based on a composition of the acquired, domain-specific multimodal content.

In some embodiments, which question/answer pairs to apply to the acquired, domain-specific multimodal content are determined using a trained machine learning process. In some embodiments, the question/answer pairs applied to the acquired, domain-specific multimodal content comprise varying levels of complexity. In some embodiments, the question/answer pairs are applied to the acquired, domain-specific multimodal content as respective layers of at least one hierarchical taxonomy.

In some embodiments, a computer-implemented method for training a language model for understanding domain-specific multimodal content includes acquiring a set of domain-specific multimodal content data for at least one content domain, using a machine learning model, creating a set of question/answer pairs to apply to the domain-specific multimodal content data, creating a training set comprising the acquired set of domain-specific multimodal content data and the created question/answer pairs, and training the language model using the training set by applying the question/answer pairs to the acquired, domain-specific multimodal content for the at least one content domain to train the language model to learn tasks associated with the domain-specific multimodal content.

In some embodiments, a method for implementing a trained language model to answer inquiries directed to domain-specific multimodal content for the at least one domain includes receiving an inquiry directed at the domain-specific multimodal content; and providing a response to the inquiry using the trained language model, the language model having been trained by acquiring a set of domain-specific multimodal content data for at least one content domain, using a machine learning model, creating a set of question/answer pairs to apply to the domain-specific multimodal content data, creating a training set comprising the acquired set of domain-specific multimodal content data and the created question/answer pairs, and training the language model using the training set by applying the question/answer pairs to the acquired, domain-specific multimodal content for the at least one content domain to train the language model to learn tasks associated with the domain-specific multimodal content.

Embodiments of the present principles advantageously provide rapid adaptation of language models, such as LLMs, without expensive end-to-end training and on hard to get domains. That is embodiments of the present principles advantageously enable the innovative ingestion of unstructured multimodal data on a small scale, such as by using proprietary information to which others do not have access. In accordance with the present principles free form responses to applied multi-level questions enable the implicit knowledge to become explicit knowledge.

As depicted in FIG. 1, embodiments of a multi-modal language model adapter of the present principles, such as the multi-modal language model adapter 100 of FIG. 1, can be implemented in a computing device 600 in accordance with the present principles. That is, in some embodiments, tasks to be performed, and/or questions intended to be answered using content data, and/or domain-specific multimodal content and the like can be communicated to components of the multi-modal language model adapter 100 of the embodiment of FIG. 1 using the computing device 600 via, for example, any input/output means associated with the computing device 600. Information associated with a multi-modal language model adapter in accordance with the present principles can be presented to a user using an output device of the computing device 600, such as a display, a printer or any other form of output device.

For example, FIG. 6 depicts a high-level block diagram of a computing device 600 suitable for use with embodiments of a comprehension-based question answering system in accordance with the present principles such as the comprehension-based question answering system 100 of FIG. 1. In some embodiments, the computing device 600 can be configured to implement methods of the present principles as processor-executable executable program instructions 622 (e.g., program instructions executable by processor(s) 610) in various embodiments.

In the embodiment of FIG. 6, the computing device 600 includes one or more processors 610a-610n coupled to a system memory 620 via an input/output (I/O) interface 630. The computing device 600 further includes a network interface 640 coupled to I/O interface 630, and one or more input/output devices 650, such as cursor control device 660, keyboard 660, and display(s) 680. In various embodiments, a user interface can be generated and displayed on display 680. In some cases, it is contemplated that embodiments can be implemented using a single instance of computing device 600, while in other embodiments multiple such systems, or multiple nodes making up the computing device 600, can be configured to host different portions or instances of various embodiments. For example, in one embodiment some elements can be implemented via one or more nodes of the computing device 600 that are distinct from those nodes implementing other elements. In another example, multiple nodes may implement the computing device 600 in a distributed manner.

In different embodiments, the computing device 600 can be any of various types of devices, including, but not limited to, a personal computer system, desktop computer, laptop, notebook, tablet or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, the computing device 600 can be a uniprocessor system including one processor 610, or a multiprocessor system including several processors 610 (e.g., two, four, eight, or another suitable number). Processors 610 can be any suitable processor capable of executing instructions. For example, in various embodiments processors 610 may be general-purpose or embedded processors implementing any of a variety of instruction set architectures (ISAs). In multiprocessor systems, each of processors 610 may commonly, but not necessarily, implement the same ISA.

System memory 620 can be configured to store program instructions 622 and/or data 632 accessible by processor 610. In various embodiments, system memory 620 can be implemented using any suitable memory technology, such as static random-access memory (SRAM), synchronous dynamic RAM (SDRAM), nonvolatile/Flash-type memory, or any other type of memory. In the illustrated embodiment, program instructions and data implementing any of the elements of the embodiments described above can be stored within system memory 620. In other embodiments, program instructions and/or data can be received, sent or stored upon different types of computer-accessible media or on similar media separate from system memory 620 or computing device 600.

In one embodiment, I/O interface 630 can be configured to coordinate I/O traffic between processor 610, system memory 620, and any peripheral devices in the device, including network interface 640 or other peripheral interfaces, such as input/output devices 650. In some embodiments, I/O interface 630 can perform any necessary protocol, timing or other data transformations to convert data signals from one component (e.g., system memory 620) into a format suitable for use by another component (e.g., processor 610). In some embodiments, I/O interface 630 can include support for devices attached through various types of peripheral buses, such as a variant of the Peripheral Component Interconnect (PCI) bus standard or the Universal Serial Bus (USB) standard, for example. In some embodiments, the function of I/O interface 630 can be split into two or more separate components, such as a north bridge and a south bridge, for example. Also, in some embodiments some or all of the functionality of I/O interface 630, such as an interface to system memory 620, can be incorporated directly into processor 610.

Network interface 640 can be configured to allow data to be exchanged between the computing device 600 and other devices attached to a network (e.g., network 690), such as one or more external systems or between nodes of the computing device 600. In various embodiments, network 690 can include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 640 can support communication via wired or wireless general data networks, such as any suitable type of Ethernet network, for example; via digital fiber communications networks; via storage area networks such as Fiber Channel SANs, or via any other suitable type of network and/or protocol.

Input/output devices 650 can, in some embodiments, include one or more display terminals, keyboards, keypads, touchpads, scanning devices, voice or optical recognition devices, or any other devices suitable for entering or accessing data by one or more computer systems. Multiple input/output devices 650 can be present in computer system or can be distributed on various nodes of the computing device 600. In some embodiments, similar input/output devices can be separate from the computing device 600 and can interact with one or more nodes of the computing device 600 through a wired or wireless connection, such as over network interface 640.

Those skilled in the art will appreciate that the computing device 600 is merely illustrative and is not intended to limit the scope of embodiments. In particular, the computer system and devices can include any combination of hardware or software that can perform the indicated functions of various embodiments, including computers, network devices, Internet appliances, PDAs, wireless phones, pagers, and the like. The computing device 600 can also be connected to other devices that are not illustrated, or instead can operate as a stand-alone system. In addition, the functionality provided by the illustrated components can in some embodiments be combined in fewer components or distributed in additional components. Similarly, in some embodiments, the functionality of some of the illustrated components may not be provided and/or other additional functionality can be available.

The computing device 600 can communicate with other computing devices based on various computer communication protocols such a Wi-Fi, Bluetooth® (and/or other standards for exchanging data over short distances includes protocols using short-wavelength radio transmissions), USB, Ethernet, cellular, an ultrasonic local area communication protocol, etc. The computing device 600 can further include a web browser.

Although the computing device 600 is depicted as a general purpose computer, the computing device 600 is programmed to perform various specialized control functions and is configured to act as a specialized, specific computer in accordance with the present principles, and embodiments can be implemented in hardware, for example, as an application specified integrated circuit (ASIC). As such, the process steps described herein are intended to be broadly interpreted as being equivalently performed by software, hardware, or a combination thereof.

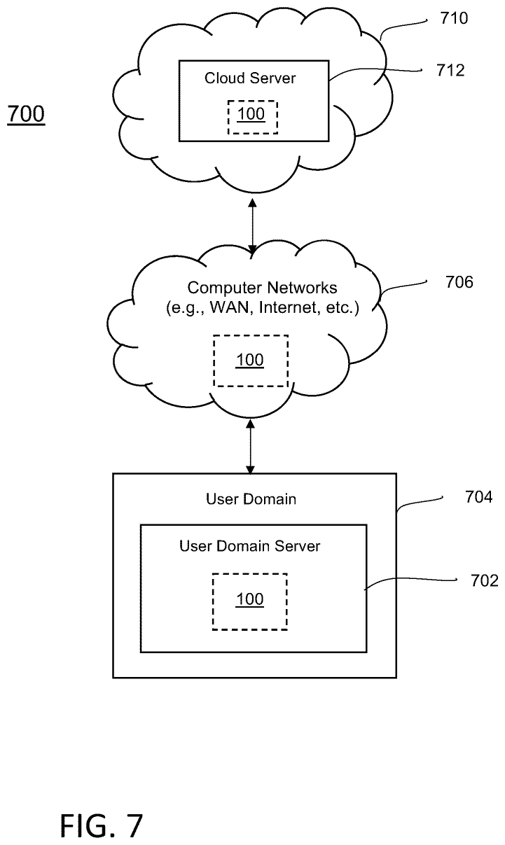

FIG. 7 depicts a high-level block diagram of a network in which embodiments of a multi-modal language model adapter in accordance with the present principles, such as the multi-modal language model adapter 100 of FIG. 1, can be applied. The network environment 700 of FIG. 7 illustratively comprises a user domain 702 including a user domain server/computing device 704. The network environment 700 of FIG. 7 further comprises computer networks 706, and a cloud environment 710 including a cloud server/computing device 712.

In the network environment 700 of FIG. 7, a multi-modal language model adapter in accordance with the present principles, such as the multi-modal language model adapter 100 of FIG. 1, can be included in at least one of the user domain server/computing device 704, the computer networks 706, and the cloud server/computing device 712. That is, in some embodiments, a user can use a local server/computing device (e.g., the user domain server/computing device 704) to train a language model (e.g., an LLM) to learn tasks for domain-specific multimodal content to adapt the language model to understand and answer questions associated with the domain-specific multimodal content in accordance with the present principles.

In some embodiments, a user can implement a multi-modal language model adapter of the present principles in the computer networks 706 to train a language model (e.g., an LLM) to learn tasks for domain-specific multimodal content to adapt the language model to understand and answer questions associated with the domain-specific multimodal content in accordance with the present principles. Alternatively or in addition, in some embodiments, a user can implement a multi-modal language model adapter of the present principles in the cloud server/computing device 712 of the cloud environment 710 to adapt the language model to understand and answer questions associated with domain-specific multimodal content in accordance with the present principles. For example, in some embodiments it can be advantageous to perform processing functions of the present principles in the cloud environment 710 to take advantage of the processing capabilities and storage capabilities of the cloud environment 710. In some embodiments in accordance with the present principles, a multi-modal language model adapter of the present principles can be located in a single and/or multiple locations/servers/computers to perform all or portions of the herein described functionalities of a system in accordance with the present principles. For example, in some embodiments some components of a multi-modal language model adapter of the present principles can be located in one or more than one of the a user domain 702, the computer network environment 706, and the cloud environment 710 while other components of the present principles can be located in at least one of the user domain 702, the computer network environment 706, and the cloud environment 710 for providing the functions of the present principles described above either locally or remotely.

Those skilled in the art will also appreciate that, while various items are illustrated as being stored in memory or on storage while being used, these items or portions of them can be transferred between memory and other storage devices for purposes of memory management and data integrity. Alternatively, in other embodiments some or all of the software components can execute in memory on another device and communicate with the illustrated computer system via inter-computer communication. Some or all of the system components or data structures can also be stored (e.g., as instructions or structured data) on a computer-accessible medium or a portable article to be read by an appropriate drive, various examples of which are described above. In some embodiments, instructions stored on a computer-accessible medium separate from the computing device 600 can be transmitted to the computing device 600 via transmission media or signals such as electrical, electromagnetic, or digital signals, conveyed via a communication medium such as a network and/or a wireless link. Various embodiments can further include receiving, sending or storing instructions and/or data implemented in accordance with the foregoing description upon a computer-accessible medium or via a communication medium. In general, a computer-accessible medium can include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods and processes described herein may be implemented in software, hardware, or a combination thereof, in different embodiments. In addition, the order of methods can be changed, and various elements can be added, reordered, combined, omitted or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of claims that follow. Structures and functionality presented as discrete components in the example configurations can be implemented as a combined structure or component. These and other variations, modifications, additions, and improvements can fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure can be implemented in hardware, firmware, software, or any combination thereof. Embodiments can also be implemented as instructions stored using one or more machine-readable media, which may be read and executed by one or more processors. A machine-readable medium can include any mechanism for storing or transmitting information in a form readable by a machine (e.g., a computing device or a “virtual machine” running on one or more computing devices). For example, a machine-readable medium can include any suitable form of volatile or non-volatile memory.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

This disclosure is to be considered as exemplary and not restrictive in character, and all changes and modifications that come within the guidelines of the disclosure are desired to be protected.

1. A method for adapting a language model for understanding domain-specific multimodal content, comprising:
acquiring domain-specific multimodal content for at least one content domain; and
applying question/answer pairs to the acquired, domain-specific multimodal content for the at least one content domain to train the language model to learn tasks associated with the domain-specific multimodal content.

2. The method of claim 1, further comprising:
using the trained language model to answer questions directed to the domain-specific multimodal content for the at least one domain.

3. The method of claim 1, further comprising:
using an in-context multimodal learning approach to train the language model to learn the tasks associated with the domain-specific multimodal content.

4. The method of claim 1, wherein the domain-specific multimodal content is acquired from at least one of a storage device, a user input, or the language model.

5. The method of claim 1, wherein the question/answer pairs are automatically selected and applied to the acquired, domain-specific multimodal content based on a composition of the acquired, domain-specific multimodal content.

6. The method of claim 1, wherein which question/answer pairs to apply to the acquired, domain-specific multimodal content are determined using a trained machine learning process.

7. The method of claim 1, wherein the question/answer pairs applied to the acquired, domain-specific multimodal content comprise varying levels of complexity.

8. The method of claim 7, wherein the question/answer pairs are applied to the acquired, domain-specific multimodal content as respective layers of at least one hierarchical taxonomy.

9. A non-transitory machine-readable medium having stored thereon at least one program, the at least one program including instructions which, when executed by a processor, cause the processor to perform a method in a processor-based system for adapting a language model for understanding domain-specific multimodal content, comprising:
acquiring domain-specific multimodal content for at least one content domain; and
applying question/answer pairs to the acquired, domain-specific multimodal content for the at least one content domain to train the language model to learn tasks associated with the domain-specific multimodal content.

10. The non-transitory machine-readable medium of claim 9, wherein the method further comprises:
using the trained language model to answer questions directed to the domain-specific multimodal content for the at least one domain.

11. The non-transitory machine-readable medium of claim 9, wherein the method further comprises:
using an in-context multimodal learning approach to train the language model to learn the tasks associated with the domain-specific multimodal content.

12. The non-transitory machine-readable medium of claim 9, wherein the domain-specific multimodal content is acquired from at least one of the non-transitory machine-readable medium, a user input, or the language model.

13. The non-transitory machine-readable medium of claim 9, wherein the question/answer pairs are automatically selected and applied to the acquired, domain-specific multimodal content based on a composition of the acquired, domain-specific multimodal content.

14. The non-transitory machine-readable medium of claim 9, wherein which question/answer pairs to apply to the acquired, domain-specific multimodal content are determined using a trained machine learning process.

15. The non-transitory machine-readable medium of claim 9, wherein the question/answer pairs applied to the acquired, domain-specific multimodal content comprise varying levels of complexity.

16. The non-transitory machine-readable medium of claim 15, wherein the question/answer pairs are applied to the acquired, domain-specific multimodal content as respective layers of at least one hierarchical taxonomy.

17. An apparatus for adapting a language model for understanding domain-specific multimodal content, comprising:
a knowledge acquisition module;
a task learning module;
a processor; and
a memory accessible to the processor, the memory having stored therein at least one of programs or instructions executable by the processor to configure the apparatus to:
acquire, using the knowledge acquisition module, domain-specific multimodal content for at least one content domain; and
apply, using the task learning module, question/answer pairs to the acquired, domain-specific multimodal content for the at least one content domain to train the language model to learn tasks associated with the domain-specific multimodal content.

18. The apparatus of claim 17, wherein the apparatus is further configured to:
use the trained language model to answer questions directed to the domain-specific multimodal content for the at least one domain.

19. The apparatus of claim 17, wherein the apparatus is further configured to: use an in-context multimodal learning approach to train the language model to learn the tasks associated with the domain-specific multimodal content.

20. The apparatus of claim 17, wherein the domain-specific multimodal content is acquired from at least one of the non-transitory machine-readable medium, a user input, or the language model.

21. The apparatus of claim 17, wherein the question/answer pairs are automatically selected and applied to the acquired, domain-specific multimodal content based on a composition of the acquired, domain-specific multimodal content.

22. The apparatus of claim 17, wherein which question/answer pairs to apply to the acquired, domain-specific multimodal content are determined using a trained machine learning process.

23. The apparatus of claim 17, wherein the question/answer pairs applied to the acquired, domain-specific multimodal content comprise varying levels of complexity.

24. The apparatus of claim 23, wherein the question/answer pairs are applied to the acquired, domain-specific multimodal content as respective layers of at least one hierarchical taxonomy.

25. A computer-implemented method for training a language model for understanding domain-specific multimodal content, comprising:
acquiring a set of domain-specific multimodal content data for at least one content domain;
using a machine learning model, creating a set of question/answer pairs to apply to the domain-specific multimodal content data;
creating a training set comprising the acquired set of domain-specific multimodal content data and the created question/answer pairs; and
training the language model using the training set by applying the question/answer pairs to the acquired, domain-specific multimodal content for the at least one content domain to train the language model to learn tasks associated with the domain-specific multimodal content.

26. A method for implementing a trained language model to answer inquiries directed to domain-specific multimodal content for the at least one domain, comprising:
receiving an inquiry directed at the domain-specific multimodal content; and
providing a response to the inquiry using the trained language model, the language model having been trained by:
acquiring a set of domain-specific multimodal content data for at least one content domain;
using a machine learning model, creating a set of question/answer pairs to apply to the domain-specific multimodal content data;
creating a training set comprising the acquired set of domain-specific multimodal content data and the created question/answer pairs; and
training the language model using the training set by applying the question/answer pairs to the acquired, domain-specific multimodal content for the at least one content domain to train the language model to learn tasks associated with the domain-specific multimodal content.
